(19) United States
(12) Patent Application Publication
(10) Pub. No.: US 2012/0027330 A1
(43) Pub. Date: Feb. 2, 2012

(54) Railway car bearing seal

(76) Inventor: Mark W.K. Fetty, Chesterfield, VA (US)

(21) Appl. No.: 12/804,717

(22) Filed: Jul. 29, 2010

(51) Int. Cl. F16C 33/76; F16C 19/24

(52) U.S. Cl. 384/477

(57) ABSTRACT

A bearing assembly is provided having a roller bearing with an inner raceway fitted around the journal portion of an axle. An outer raceway combines with the inner raceway to receive roller elements. An improved lubricant seal arrangement is provided between the wear ring and the supporting outer raceway comprising a slinger element.

### BACKGROUND OF THE INVENTION

This invention relates to shaft journal bearings and, more particularly, to an improved bearing assembly seal arrangement for use in a railway freight car.

Roller bearing assemblies incorporating two rows of tapered roller bearings preassembled into a self-contained, pre-lubricated package for assembly onto journals at the ends of axles or shafts are known. Such bearing assemblies are used as rail car bearings assembled onto journals at the ends of the axles. Bearings of this type typically employ two rows of tapered roller bearings fitted one into each end of a common bearing cup with their respective bearing cones having an inner diameter dimensioned to provide an interference fit with the shaft journal and with a cylindrical sleeve or spacer positioned between the cones providing accurate spacing and proper lateral clearance on the journal. Seals mounted within each end of the bearing cup provide sealing contact with wear rings bearing against the outer ends or back face of the respective bearing cones at each end of the assembly. Such seals are shown in U.S. Pat. Nos. 5,975,533, 7,607,836, and 7,534,047.

In a typical rail car installation, the axle journal is machined with a fillet at the inboard end. A backing ring having a surface complementary to the contour of the fillet and an abutment surface for engaging the inboard end of an inner wear ring accurately position the bearing assembly on the journal. An end cap mounted on the end of the axle by bolts threaded into bores in the end of the axle engages the outboard wear ring and clamps the entire assembly on the end of the axle. The wear rings typically have an inner diameter dimensioned to provide interference fit with the journal over at least a portion of their length so that the entire assembly is pressed as a unit onto the end of the journal shaft portion of the axle.

### SUMMARY OF THE INVENTION

The bearing assembly of the present invention is a roller bearing that includes an inner race or cone fitted around the journal portion of the axle or shaft. The inner race includes an outwardly directed raceway. An outer race or cup has an inwardly directed raceway. Roller elements are located between and contacting the inner and outer raceways.

A backing ring has a contoured surface complementary to and engaging the contoured surface of a fillet formed on the shaft. The fillet leads from the journal to the shoulder of the shaft. The contoured surfaces cooperate to fix the backing ring against axial movement along the shaft.

The bearing assembly includes a seal assembly that provides a barrier for lubricant to be retained within the seal assembly and for contaminants to be kept out. A slinger is provided to interact with a wear ring and a seal element to provide an improved seal. The inter-related relationship between the seal element, wear ring, and slinger act to retain the lubricant within the seal assembly and to keep contaminants out.

### BRIEF DESCRIPTION OF THE DRAWINGS

In the drawings,

FIG. 1 is a sectional view of a shaft journal having mounted thereon a tapered roller bearing assembly in accordance with a first embodiment of the present invention;

FIG. 2 is a detailed partial view in cross section of a tapered roller bearing seal assembly in accordance with the first embodiment of the present invention;

FIG. 3 is a detailed view in partial cross section of a tapered roller bearing assembly in accordance with a second embodiment of a present invention, and

FIG. 4 is a detailed view in partial cross section of a tapered roller bearing assembly in accordance with a third embodiment of the present invention.

### DESCRIPTION OF THE PREFERRED EMBODIMENTS

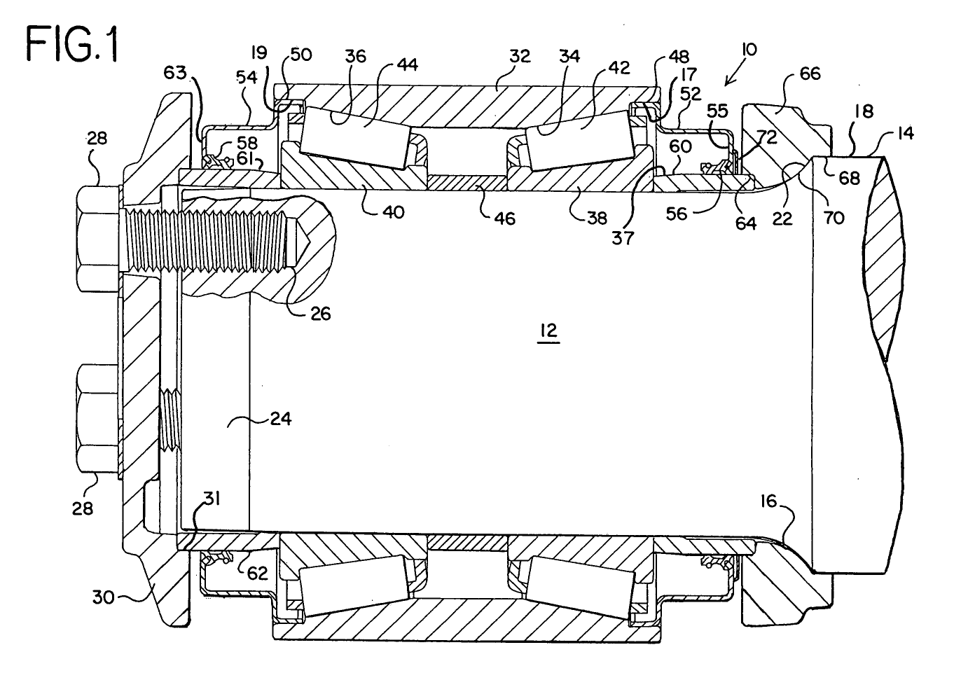

Referring now to FIG. 1 of the drawings, a bearing assembly indicated generally by the reference numeral 10 on FIG. 1 is shown mounted on a journal 12 on the free, cantilevered end of a shaft or axle 14, typically a rail car axle. Journal 12 is machined to very close tolerances and terminates at its inner end in a contoured fillet 22 leading to a cylindrical shoulder 18 of axle 14. At the free end of the axle, journal portion 12 terminates in a slightly conical or tapered guide portion 24 dimensioned to facilitate installation of the bearing assembly onto the journal. A plurality of threaded bores 26 are formed in the end of axle 14 for receiving threaded cap screws, or bolts 28 for mounting a bearing retaining cap 30 on the end of the shaft to clamp the bearing in position as described more fully herein below.

Bearing assembly 10 is preassembled before being mounted and clamped on journal 12 by retaining cap 30 and bolts 28. The bearing assembly includes a unitary bearing cup or outer raceway 32 having a pair of inner facing raceways 34,36 formed one adjacent each end thereof which cooperate with a pair of bearing cones 38,40, having outer facing raceways respectively, to support the two rows of tapered rollers 42,44, respectively there between. A center spacer 46 is positioned between cones 38, 40 to maintain the cones in accurately spaced position relative to one another allowing for proper bearing lateral clearance.

Bearing cup 32 is provided with cylindrical counterbores 17,19 at its axially outer ends and a pair first end sections 48, 50 of seal sections 52,54 are pressed one into each of the cylindrical counterbores 17,19 in cup 32. Each second end section 55, 63 of seal section 52,54 may include resilient sealing elements 56, 58 which rub upon and form a seal with radial outer surfaces 37,61 of a pair of seal wear rings 60,62 having an inwardly directed end in engagement with the outwardly directed ends of bearing cones 38,40 respectively. Seal section 54 is similar to seal section 52 and will not be described in detail. The other end of wear ring 60 is received in a cylindrical counterbore 64 in the axially outwardly directed end of an annular backing ring 66 which, in turn, has a counterbore 68 at its other end which is dimensioned to be received in interference and non-interference relation on the cylindrical shoulder 18 of shaft 14. The counterbore 64 and the outer diameter of wear ring 60 are also dimensioned to provide an interference fit so that wear ring 60 is pressed into the backing ring 66 which is accurately machined to provide a contoured inner surface 70 complementary to and engaging the contour of fillet 22 when the bearing is mounted on the shaft. The outwardly directed end of wear ring 62 bears against a counterbore 31 in a retaining cap 30.

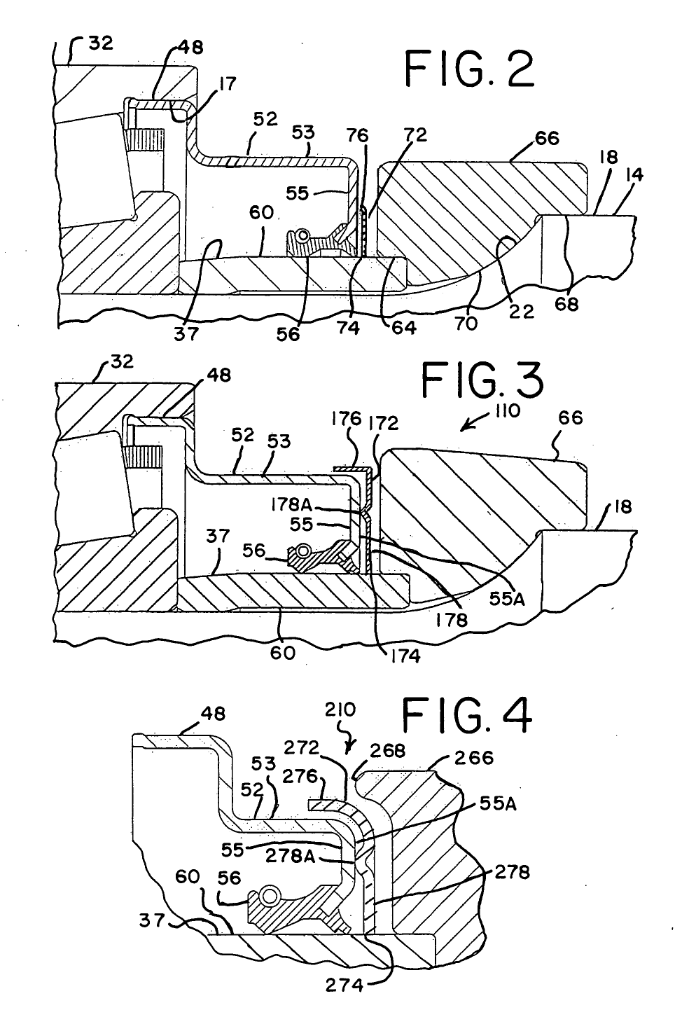

Referring now to FIG. 2, a detailed view of seal assembly portion of bearing assembly 10 is provided. Seal section 52 is seen to comprise a generally cylindrical piece, having a larger diameter first end section 48 pressed or fit into a complementary counterbore 17 in a cup 32. Seal section 52 includes an intermediate section 27 normal to first end section 48 and a main intermediate cylindrical section 53 that extends parallel to end section 48, wherein main intermediate cylindrical section 53 has a smaller diameter than first end section 48.

Second end section 55 of seal section 52 extends from main intermediate section 53 at a normal angle thereto. Resilient sealing element 56 is fitted onto second end section 55. Resilient sealing element 56 is comprised of a rubber or elastomer compound, such as nitrile rubber compound. Resilient sealing element 56 includes a main section that includes an opening to receive second end section 55 of seal section 52.

Slinger section 72 comprises a generally cylindrical structure having a base section 74 attached to outer surface 37 of seal wear ring 60 and end section 76 extending from base section 74. Slinger section 72 is usually a unitary structure comprised of a structural plastic or steel.

Referring now to FIG. 3, a second embodiment of the roller bearing seal assembly of the present invention is shown generally at 110. Elements such as bearing cup 32, backing ring 66, seal section 52 and seal wear ring 60 are similar to FIGS. 1 and 2 and are similarly numbered.

Slinger section 172 comprises a generally cylindrical structure having a base section 174 attached to outer surface 37 of seal wear ring 60, an intermediate section 178 extending from base section 174, and end section 176 extending from and at an angle of approximately 90 degrees to intermediate section 178. Intermediate section 178 is seen to have a protrusion 178A that contacts the axially inward facing surface 55A of second end section 55 of seal section 52. Slinger section 172 is usually a unitary structure comprised of a structural plastic or steel. Slinger end section 176 extends toward and is adjacent the radial outer surface of main intermediate cylindrical section 53 of seal section 52.

Referring now to FIG. 4, a third embodiment of the roller bearing seal assembly of the present invention is shown generally at 210. Elements such as seal section 52 and seal wear ring 60 with radial outer surface 37 are similar to FIGS. 1 and 2 and are similarly numbered. However, backing ring 266 is seen to have an annular protrusion 268 extending axially from its outer radial surface.

Slinger section 272 comprises a generally cylindrical structure having a base section 274 attached to outer surface 37 of seal wear ring 60, an intermediate section 278 extending from base section 274, and end section 276 extending from and normal to intermediate section 278. Slinger section 272 is usually a unitary structure comprised of a structural plastic or steel. Intermediate section 278 is seen to have a protrusion 278A that contacts the axially inward facing surface 55A of second end section 55 of seal section 52. Slinger end section 276 extends at a radius and an angle of approximately 90 degrees from intermediate section 278 and extends toward and is adjacent the radial outer surface of main intermediate cylindrical section 53 seal section 52.

What is claimed is:

1. A roller bearing assembly comprising:
a generally cylindrical cone having a generally cylindrical, outwardly directed raceway thereon,
a generally cylindrical cup having a generally cylindrical, inwardly directed raceway thereon,
the cone having a generally flat, axially inward face,
the cup having a radially inward facing cylindrical counterbore,
a generally cylindrical wear ring adjacent and axially inward from the generally flat, axially inward face of the cone,
the wear ring having a generally cylindrical outer surface,
a seal of generally cylindrical configuration,
the seal having a first end section, an intermediate section and a second end section,
the first end section received in the radially inward facing cylindrical counterbore of the cup,
a resilient sealing element affixed to the second end section of the sealing element, the resilient sealing element contacting the generally cylindrical outer surface of the wear ring,
and a slinger element of a generally cylindrical configuration having a base section affixed to the generally cylindrical outer surface of the wear ring and a radial outer edge adjacent the second end section of the seal.

2. The roller bearing assembly of claim 1 wherein
the slinger element extends radially about half the length of the second end section of the seal.

3. The roller bearing assembly of claim 1
wherein the radial outer edge of the slinger element is turned axially outward toward the second end section of the seal.

4. The roller bearing assembly of claim 1
wherein the slinger element includes a middle section that contacts the second end section of the seal, and the radial outer edge of the slinger element includes a radially outward end extending beyond the intermediate section of the seal.

5. The roller bearing assembly of claim 4
wherein the slinger element radially outward end extends normal to the base section.

6. The roller bearing assembly of claim 4
wherein the second end section of the seal extends from the intermediate section of the seal at a radius 90 degree bend, and the slinger element radially outward end extends from the base section at a radius of approximately 90 degrees bend.

7. A roller bearing assembly comprising:
a generally cylindrical cone having a generally cylindrical, outwardly directed raceway thereon,
a generally cylindrical cup having a generally cylindrical, inwardly directed raceway thereon,
the cone having a generally flat, axially inward face,
the cup having a radially inward facing cylindrical counterbore,
a generally cylindrical wear ring adjacent and axially inward from the generally flat, axially inward face of the cone,
the wear ring having a generally cylindrical outer surface,
a seal of a generally cylindrical configuration,
the seal having a first end section, an intermediate section and a second end section, the first end section received in the inward facing cylindrical counterbore of the cup,
and a slinger element of a generally cylindrical configuration having a base section affixed to the generally cylindrical outer surface of the wear ring, the slinger element extending radially from a position on the wear ring axially inward from the second end section of the seal.

8. The roller bearing assembly of claim 7 further comprising,
a resilient sealing element affixed to the second end section of the seal, the resilient sealing element contacting the outer surface of the wear ring.

9. The roller bearing assembly of claim 7
wherein the slinger element extends radially about half the length of the second end section of the seal.

10. The roller bearing assembly of claim 7
wherein the slinger element includes a radial outer edge that extends axially . outward toward the second end section of the seal.

11. The roller bearing assembly of claim 7
wherein the slinger element includes a middle section that contacts the second end section of the seal, and the slinger element includes a radial outer edge having a radially outer end extending beyond the intermediate section of the seal.

12. The roller bearing assembly of claim 11
wherein the slinger element radially outward end extends normal to the base section.

13. The roller bearing assembly of claim 11
wherein the second end section of the seal extends from the intermediate section of the seal at a radius 90 degree bend, and the slinger element radially outward end extends from the base section at a radius of approximately 90 degrees bend.
